(19) United States
(12) Patent Application Publication
(10) Pub. No.: US 2011/0199061 A1
(43) Pub. Date: Aug. 18, 2011

(54) AC VOLTAGE CONTROL DEVICE

(76) Inventor: Ryuichi Shimada, Tokyo (JP)

(21) Appl. No.: 13/125,851

(22) PCT Filed: Oct. 28, 2008
(86) PCT No.: PCT/JP2008/069991

§ 371 Date: Apr. 25, 2011

(30) Foreign Application Priority Data
Oct. 27, 2008 (JP) 2008-275061

(51) Int. Cl. G05F 1/445; G05F 1/455

(52) U.S. Cl. 323/237

(57) ABSTRACT

Provided is an AC voltage control device for adjusting the voltage of a load to be connected with an AC power source, by a convenient method.

In this AC voltage control device, a magnetic energy recovery switch including a capacitor and an AC switch circuit connected in parallel is connected between the AC power source and the load. The AC switch circuit is turned on several ms from such a timing of a zero capacitor voltage as occurs twice for one current cycle, so that a capacitor current is bypassed to reduce a reactance voltage thereby to adjust the voltage of the load.

### TECHNICAL FIELD

The present invention generally relates to a device that is realized by a magnetic energy recovery switch connected between an AC power source and a load, and controls the load voltage and current.

### BACKGROUND ART

There has been a disclosed technology by which a magnetic energy recovery switch (hereinafter referred to as MERS) is inserted between an AC power source and a load so as to advance the phase of current and control the load voltage (see Japanese Patent Application Laid-Open No. 2004-260991, for example).

The MERS includes four reverse-conductive type semiconductor switches, and needs four gate control signals to be generated (The MERS of this aspect will be hereinafter referred to as the full-bridge MERS).

On the other hand, it is already known that there has been a simplified MERS circuit of a horizontal-half type (hereinafter referred to as the horizontal-half MERS) that includes only two reverse-conductive type semiconductor switches, though the function of the full-bridge MERS is partially limited (see Japanese Patent Application Laid-Open No. 2007-058676, for example).

In the horizontal-half MERS, a circuit formed by connecting two reverse-conductive type semiconductor switches in anti-series is connected in parallel to a capacitor that stores the magnetic energy. The limitation of the horizontal-half MERS is that, even if the gates of all the reverse-conductive type semiconductor switches are switched off, current flows into the capacitor, and the load current cannot be shut off completely. However, the horizontal-half MERS has the advantage that the number of required components is small, and has no problems as a MERS for voltage control and power factor control. If power MOSFETs are used as the reverse-conductive type semiconductor switches in the horizontal-half MERS, the source terminals of the power MOSFETs can be connected to each other in the direction in which the two reverse-conductive type semiconductor switches are connected in anti-series. With this arrangement, the gates of the two power MOSFETs can be driven by a common gate power source, and accordingly, the circuit is simplified. However, the phase of the gate control signal needs to be controlled.

### SUMMARY OF THE INVENTION

### Problems to be Solved by the Invention

If the number of semiconductor switch elements constituting the AC switch circuit is two, and the method of controlling the gates of the semiconductor switch elements is simple, the horizontal-half MERS can become a widely-used AC switch, like AC switches that use thyristors or triacs and are widely used as AC voltage control devices. The horizontal-half MERS can characteristically realize an AC switch that adjusts an AC voltage, using a leading current, as opposed to a conventional AC triac device. That is, the horizontal-half MERS can realize a dual circuit, as opposed to an AC triac device.

An even simpler version of the horizontal-half MERS with a limited load current shut-off function of the full-bridge MERS including four reverse-conductive type semiconductor switches is used to provide the function to recover magnetic energy, the function to control advance of the phase of current, and the function of a capacitance-variable capacitor. In this manner, the range of use of entire magnetic energy recovery switches is to be made wider.

The present invention aims to provide an AC voltage control device realized by a novel magnetic energy recovery switch that allows use of not only reverse-conductive type semiconductor switches but also other self-turn-off semiconductor devices by reducing the number of reverse-conductive type semiconductor switches from four of the full-bridge MERS to two, and implementing a simpler gate control method.

### Means for Solving the Problems

The present invention provides an AC voltage control device that is inserted between an AC power source and a load, performs a control operation to increase and decrease the load voltage, and has a variable reactance voltage generating function. The above object of the present invention is achieved by the AC voltage control device that comprises: a variable reactance voltage generator circuit that includes an AC switch circuit and a capacitor that is connected in parallel to the AC switch circuit and stores the magnetic energy when a current of the AC switch circuit is shut off, the AC switch circuit including two reverse-conductive type field effect transistors (hereinafter referred to as the FETs), the source of a first FET of the two FETs being connected to the source of a second FET of the two FETs (i.e. “anti-series connection”); a control unit that supplies a control signal to the respective gates of the first and second FETs, and controls switching on and off of the AC switch circuit; and a capacitor-voltage zero detection circuit that detects the time when the voltage of the capacitor becomes almost zero, and transmits an ON signal about the AC switch circuit to the control unit.

The control unit causes the capacitor to store (charge the capacitor) and recover (discharge the capacitor) the magnetic energy when the current is shut off to generate a reactance voltage by simultaneously switching off the two FETs of the AC switch circuit a predetermined period of time after simultaneously switching on the two FETs at the time of receipt of the ON signal, the control unit adjusting the increase and the decrease of the load voltage by varying the reactance voltage through adjustment of the predetermined period of time.

The above object of the present invention is also achieved by replacing the AC switch circuit with an AC switch circuit that includes diode bridges and a self-turn-off semiconductor switch such as a GTO thyristor, an IGBT, an IEGT, a GCT thyristor, or a power MOSFET, the self-turn-off semiconductor switch being connected between the DC terminals of the diode bridges, or by replacing the AC switch circuit with an AC switch circuit that includes a triac or two thyristors connected in anti-parallel to each other.

Further, the above object of the present invention is effectively achieved by connecting a surge absorber circuit in series to the capacitor in the variable reactance voltage generator circuit, the surge absorber circuit being formed by connecting a resistor and a coil in parallel to each other.

### BRIEF DESCRIPTION OF THE DRAWINGS

FIG. 1 is a block diagram illustrating the structure of Embodiment 1 of an AC voltage control device realized by a magnetic energy recovery switch according to the present invention.

FIG. 2(A) is a diagram illustrating a simulation model of an operation of the conventional horizontal-half magnetic energy recovery switch, and FIG. 2(B) is a diagram illustrating the results of the simulation.

FIG. 3(A) is a diagram illustrating a simulation model of an operation of Embodiment 1 of the present invention, and FIG. 3(B) is a diagram illustrating the results of the simulation.

FIG. 4 is block diagrams illustrating (only part of) the structure of an AC voltage control device of Embodiment 2 of the present invention: (A) illustrates a case where one power MOSFET is used; and (B) illustrates a case where one GTO thyristor is used.

FIG. 5 is a block diagram illustrating (only part of) the structure of Embodiment 3 of an AC voltage control device of the present invention that includes a triac as an AC switch circuit.

FIG. 6(A) is a diagram illustrating a simulation model of Embodiment 3 of the present invention, and FIG. 6(B) is a diagram illustrating the results of the simulation.

FIG. 7 is a diagram illustrating an example of a surge absorber circuit connected in series to a capacitor.

### BEST MODE FOR CARRYING OUT THE INVENTION

The following is a description of embodiments of the present invention, with reference to the accompanying drawings. Like components, parts, and processes illustrated in the respective drawings are denoted by like reference characters, and explanation of them will not be repeated more than once. Those embodiments do not limit the invention but are merely examples, and all the features and the combinations of them described below as embodiments are not necessarily essential to the invention.

According to the present invention, a MERS connecting a capacitor and an AC switch circuit in parallel to each other is connected between an AC power source and a load, and the AC switch circuit is switched on when the voltage of the capacitor becomes zero, which occurs twice in each cycle of the AC power source. The current flowing in the capacitor is bypassed to the AC switch circuit, and the reactance voltage is reduced to adjust the load voltage. Accordingly, there is no need to control switching on and off of the gates of the reverse-conductive type semiconductor switches with a pulse synchronized with the source voltage as in the full-bridge MERS and the horizontal-half MERS.

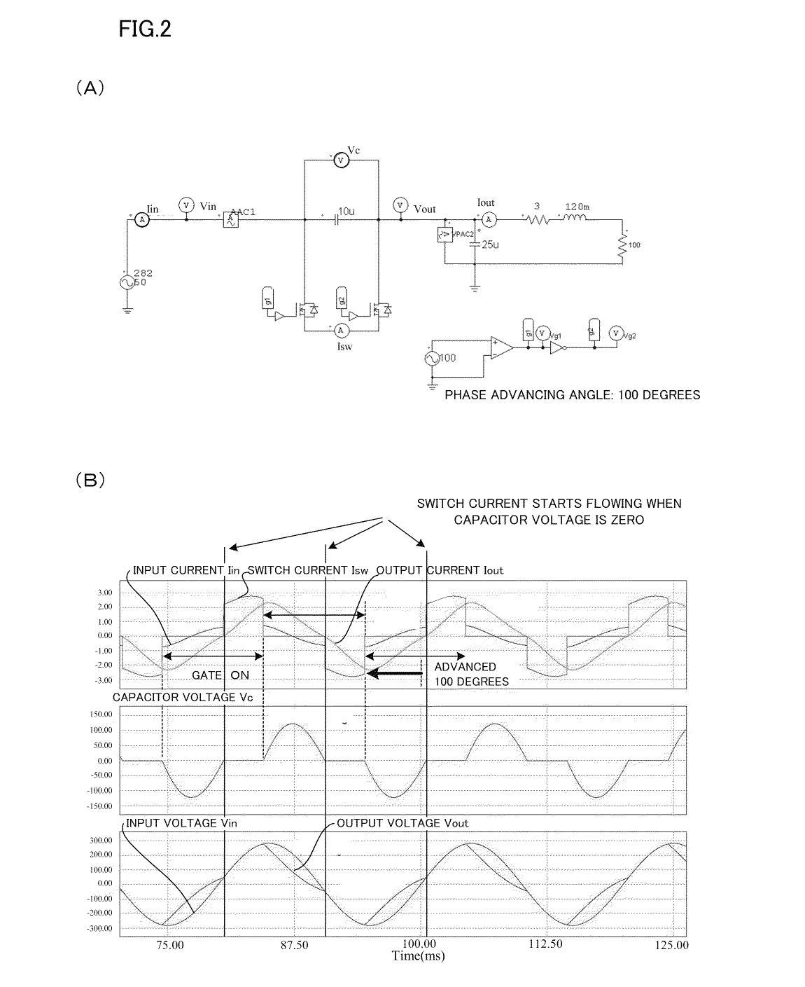

FIG. 2(A) illustrates a simulated circuit using the horizontal-half MERS. FIG. 2(B) illustrates the results of a simulation performed where the phase of the gate control signal in the simulated circuit illustrated in FIG. 2(A) is advanced 100 degrees. More specifically, FIG. 2(B) illustrates a source current, a load current, a gate control signal, a capacitor voltage, a source voltage, and a load voltage. As illustrated in FIG. 2(B), when the capacitor voltage is zero, current starts flowing into reverse-conductive type semiconductor switches, and a capacitor 2 is short-circuited. After a predetermined period of time has passed, the reverse-conductive type semiconductor switches S1 and S2 are switched off. Accordingly, a reactance voltage is generated in the capacitor by the recovered current, and the load voltage becomes lower. After that, the polarity of the source is reversed, and the capacitor voltage Vc is lowered back to zero. At this point, the reverse-conductive type semiconductor switches are switched on, to cause short-circuiting and prevent current from flowing into the capacitor 2. In this case, the conduction electric angle is advanced 100 degrees by the gate control signal. However, the period of conduction time is 3.98 ms.

That is, when the voltage of the capacitor is zero, the reverse-conductive type semiconductor switches are switched on, and the current flowing into the capacitor bypasses the capacitor. Accordingly, the operation of the horizontal-half MERS can be controlled by adjusting the period of time during which the current bypasses the capacitor. With this arrangement, there is no need to detect the phase of the source voltage to control the gates of the reverse-conductive type semiconductor switches, which is a significant feature of the present invention.

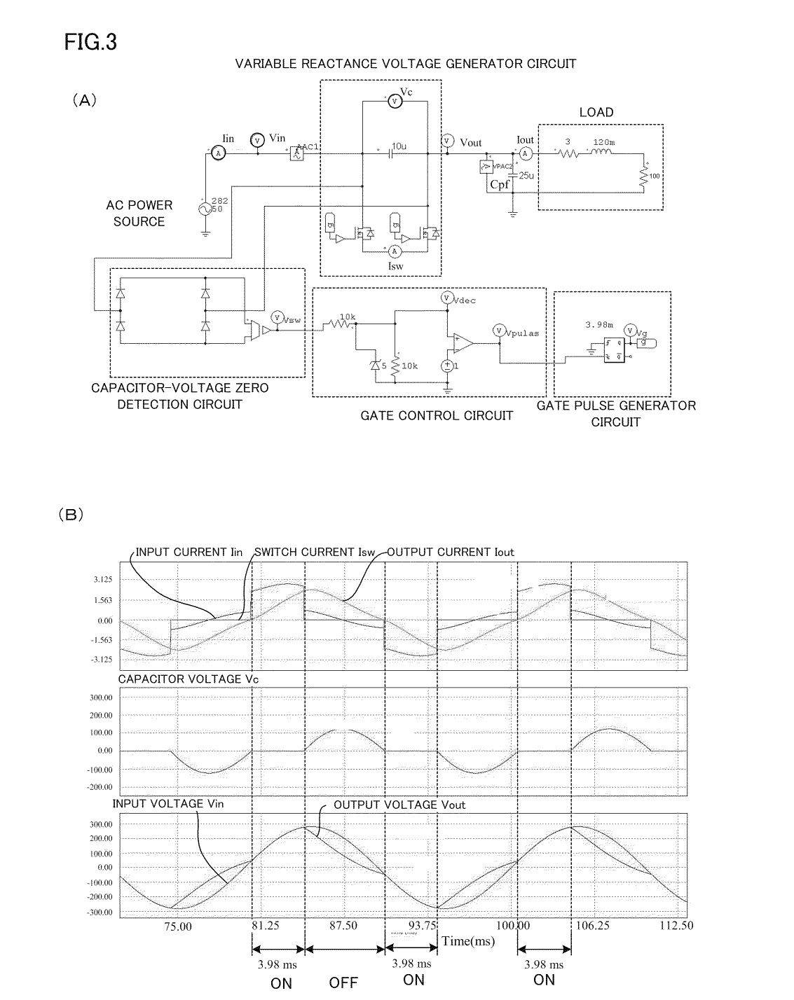

FIG. 3 illustrates a structure formed by connecting an AC switch circuit and a capacitor in parallel to each other switches off the AC switch circuit after the capacitor is short-circuited for 3.98 ms since the voltage of the capacitor became zero. This operation of the structure is equivalent to the magnetic energy recovering operation illustrated in FIGS. 2(A) and 2(B). As can be seen from the above aspects, a novel method of controlling a horizontal-half MERS in a simpler manner than in conventional cases has been developed. According to the novel method, the phase of the source voltage is not detected, and the AC switch circuit that short-circuits the capacitor is switched on when the voltage of the capacitor is zero. In this manner the voltage of the capacitor is controlled.

Also, since the two reverse-conductive type semiconductor switches connected in anti-series to each other are simultaneously switched on and off, only one gate control circuit suffices, which is an advantage of the present invention. Furthermore, in a case where power MOSFETs are used as the reverse-conductive type semiconductor switches, the gates are on at the time of reverse conduction. Therefore, a synchronous rectifying operation is performed to make the conduction resistance lower than that in a case where only the parasitic diodes are energized. The conduction loss can be minimized, and accordingly, the conduction loss of the AC switch circuit can be made advantageously reduced.

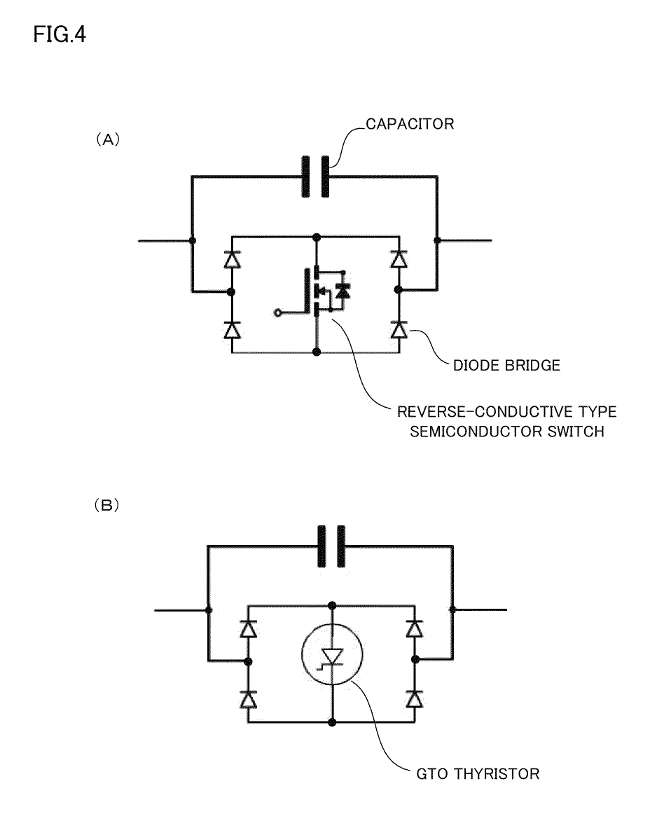

FIG. 4 illustrates an example case where the AC switch circuit that switches on the semiconductor switches when the voltage of the capacitor becomes zero includes diode bridges and a self-turn-off semiconductor switch, such as a GTO thyristor, an IGBT, an IEGT, a GCT thyristor, or a power MOSFET. It is apparent that the control method according to the present invention can also be implemented where the circuit illustrated in FIG. 4 is used as the AC switch circuit. The number of semiconductor switch elements is one, and an operation equivalent to the operation of a horizontal-half MERS can be performed. Accordingly, only one gate control circuit is required, and the number of components is reduced. Thus, the AC voltage control device becomes advantageously smaller.

### EMBODIMENTS

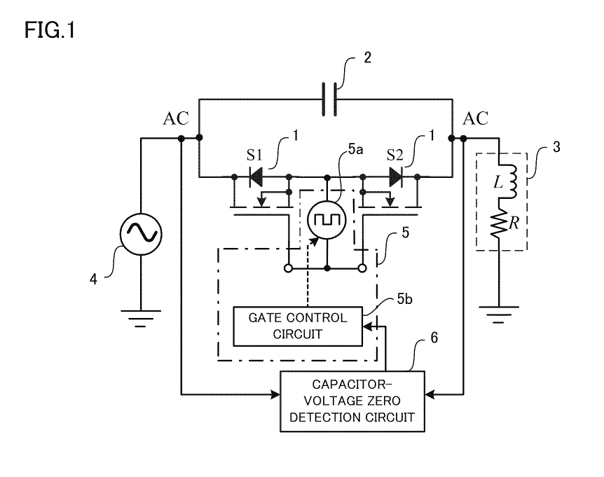

FIG. 1 illustrates an embodiment according to claim 1 (hereinafter referred to as Embodiment 1). Power MOSFETs are used as reverse-conductive type semiconductor switches. Two power MOSFETs S1 and S2 are connected in anti-series so that the source terminals are connected to each other. In this manner, an AC switch circuit is formed. A capacitor 2 that stores magnetic energy is connected between the two drain terminals. A gate pulse generator circuit 5a is connected between the sources and the gates of the power MOSFETs S1 and S2, and the timing to switch the gates of the power MOSFETs on and off is controlled by a gate control circuit 5b. It should be noted that the “control unit” in claim 1 has both functions of the gate pulse generator circuit 5a and the gate control circuit 5b. A capacitor-voltage zero detection circuit 6 detects the time when the voltage of the capacitor 2 becomes zero, and transmits the detection signal to the gate control circuit 5b.

Receiving the signal from the capacitor-voltage zero detection circuit 6, the gate control circuit 5b determines the timing to start generating a pulse. The time equivalent to the pulse width set here is 3.98 ms, for example, and the capacitor 2 is short-circuited during that time.

FIG. 3(A) illustrates a simulated circuit of the circuit of Embodiment 1 illustrated in FIG. 1, in conjunction with circuit constants. An AC power source has an effective voltage of 200 Vrms and a power-supply frequency f of 50 Hz. A load 3 has a resistance component R of 100Ω and an inductance component L of 120 mH (an internal resistance of 3Ω). With this arrangement, a mercury lamp of a reactor stabilizer type having a high power factor is hypothetically formed. Therefore, a power-factor improving capacitor Cpf of 25 μF is connected in parallel to the load 3.

In a case where the load has only a low power factor without the power-factor improving capacitor Cpf, the value of the capacitance of the capacitor 2 should be made smaller than the condition for resonance with the inductance L of the load 3, to switch the reverse-conductive type semiconductor switches on and off without voltage and current when the voltage of the capacitor 2 reaches zero after the capacitor 2 release charges as the polarity of the current is reversed. Here, the capacitance of the capacitor is set at 10 μF.

In the simulated circuit illustrated in FIG. 3(A), the power-factor improving capacitor Cpf is connected in parallel to the load 3, to improve the power factor of the load 3. However, the power-factor improving capacitor Cpf presents no problems in operations.

FIG. 3(B) illustrates the results of the simulation of FIG. 3(A). As can be seen from the results, while the AC power source voltage is 200 Vrms, the load voltage decreases from 200 Vrms to 162 Vrms.

In the present invention, the time when the voltage of the capacitor 2 is zero is detected, and the AC switch circuit is then switched on. The relationship between the ON time and the load voltage is illustrated below.

| ON time | load voltage | |
|---|---|---|
| 1 ms | 83 | Vrms |
| 2 ms | 114 | Vrms |
| 3 ms | 141 | Vrms |
| 4 ms | 162 | Vrms |
| 5 ms | 178 | Vrms |
| 6 ms | 188 | Vrms |
| 7 ms | 194 | Vrms |

FIG. 4 illustrates an embodiment according to claim 2 (hereinafter referred to as Embodiment 2). The AC switch circuit is realized by combining diode bridges with a self-turn-off semiconductor switch. When the voltage of the capacitor becomes zero, a gate control signal is transmitted to the gate of the self-turn-off semiconductor switch. In this manner, the self-turn-off semiconductor switch is switched on, and the voltage of the capacitor is clamped. As in Embodiment 1, after a predetermined period of time, the gate control signal is transmitted to the gate of the self-turn-off semiconductor switch to switch the self-turn-off semiconductor switch off. A reactance voltage is then generated in the capacitor.

In the case illustrated in FIG. 4, the diode bridges hinder the flow of reverse currents. Therefore, a self-turn-off semiconductor device (that can be switched on and off) can be used, and it is possible to use a reverse-conducting GTO thyristor, an IGBT, an IEGT, a GCT thyristor, a power MOSFET, or the like.

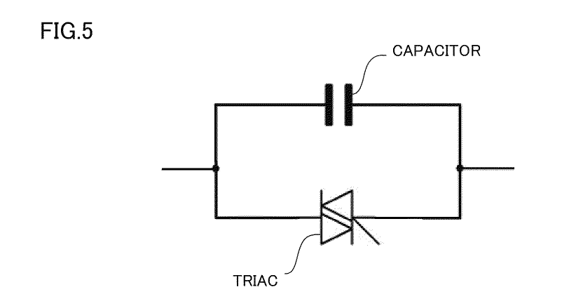

FIG. 5 illustrates an embodiment according to claim 3 (hereinafter referred to as Embodiment 3). Instead of the AC switch circuit of Embodiment 1 formed by power MOSFETs that are connected in anti-series to each other, an AC switch circuit formed by one triac is connected in parallel to the capacitor 2, and when the voltage of the capacitor 2 becomes zero, the control unit 5 then switches on the triac, and causes short-circuiting so as not to allow the capacitor 2 to generate voltage. Alternatively, the control unit 5 does not switch the triac on, so as to cause the capacitor 2 to generate reactance voltage. In this manner, the control unit 5 can increase and decrease the load voltage though stepwise. Embodiment 3 is the simplest aspect of an AC voltage control device.

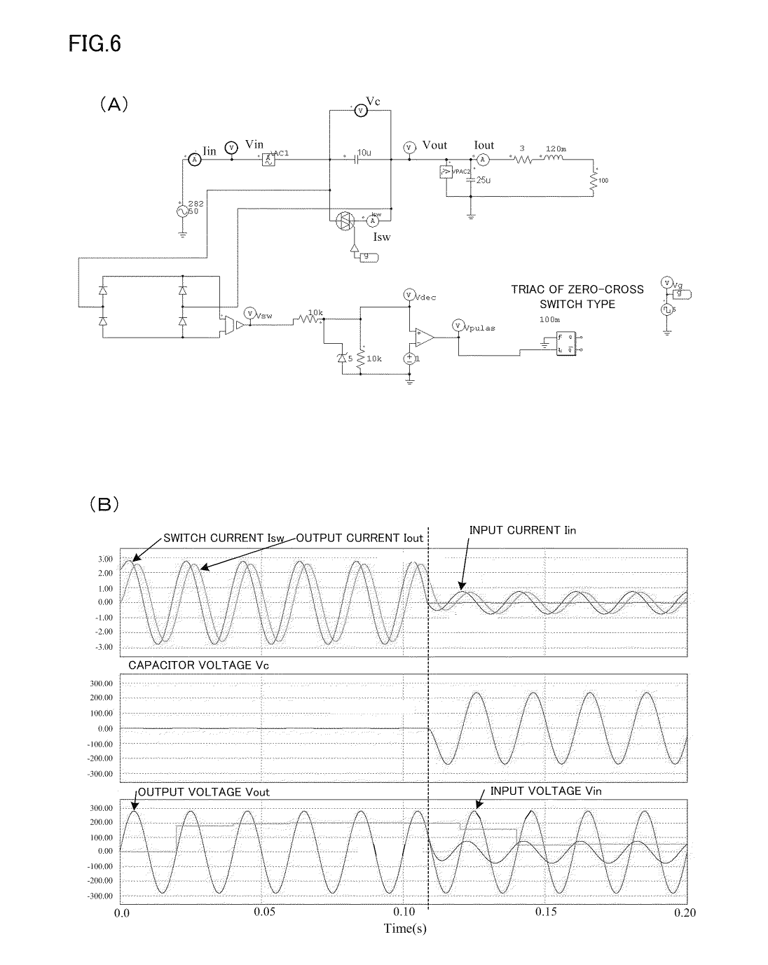

FIG. 6 illustrates a simulated circuit (FIG. 6(A)) of the circuit illustrated in FIG. 5, and the simulation results (FIG. 6(B)). The load voltage (the output voltage) rapidly varies from 200 Vrms to 55 Vrms stepwise. Although simple control is performed by inserting the capacitor 2 in series between the AC power source 4 and the inductive load 3, this control is effective as long as the triac is switched on when the voltage of the capacitor 2 becomes zero. A solid-state relay (SSR) that uses an insulating triac such as an optically-coupled device and has a zero-cross switch function can be used. For example, this embodiment can also be used depending on the intended use, since the output control on small motors for electric fans and the like, and the brightness control on fluorescent lamps involve load voltages that do not vary in a continuous manner but can increase and decrease stepwise.

With an AC voltage control device according to the present invention, the number of semiconductor switch elements forming an AC switch circuit can be reduced, and there is no need to perform switching in synchronization with detection of the phase of the voltage of the AC power source. Accordingly, the circuit can be simplified. Also, since the two FETs can be simultaneously switched on and off by one gate control circuit, the gate pulse generator circuit can also be simplified. Also, triacs, thyristors, and the like can be used as the semiconductor switch elements forming the AC switch circuit.

### INDUSTRIAL APPLICABILITY

The MERS according to the present invention is a magnetic energy recovery switch that stores the magnetic energy of current in a capacitor, and recovers the energy in a load without loss. This MERS has novel aspects and involves a novel control method. Unlike thyristors and triacs as conventional AC switches, the horizontal-half MERS is capable of controlling the load voltage with a capacitor connected in parallel to the AC switch circuit, without intermission of the load current.

For the above described reason, continuous brightness control can be performed where the AC voltage control device according to the present invention is used in an electric-discharge lamp having inductive properties, such as a fluorescent lamp, a mercury lamp, or a sodium vapor lamp. Specifically, in the simulated circuit illustrated in FIG. 3(A), for example, the set time constant of the monostable multivibrator circuit in the last stage of the gate pulse generator circuit 5a is varied by a variable resistor or the like, so as to adjust the ON time of the power MOSFETs. In this manner, continuous brightness control can be performed on an electric-discharge lamp.

In a case where the inductive load to be connected is an induction motor, the load voltage can be increased and can be decreased by the AC voltage control device according to the present invention. Thus, the AC voltage control device may be readily used in an electric motor control system that controls outputs of an electric motor.

In the conventional full-bridge MERS, the respective gates of the four reverse-conductive type semiconductor switches need to be driven. In Embodiment 1 of the AC voltage control device according to the present invention illustrated in FIG. 1, on the other hand, a horizontal-half MERS including two reverse-conductive type semiconductor switches is used. Furthermore, the time when the voltage of the capacitor becomes zero is detected, and the capacitor is then short-circuited by the AC switch circuit. Accordingly, there is no need to detect the phase of the voltage of the AC power source.

Also, in the AC voltage control device according to the present invention, a simple common-grounded gate pulse generator circuit can be used to simultaneously switch the two reverse-conductive type semiconductor switches on. In a case where power MOSFETs are used as the reverse-conductive type semiconductor switches, when the gates are switched on at the time of reverse conduction, the conduction resistance becomes lower than the conduction resistance in the parasitic doped conduction. Accordingly, the conduction loss becomes even smaller.

Although the present invention is applied to single-phase circuits in the above description, the present invention can of course be applied to a three-phase AC power source by inserting the novel aspect of horizontal-half MERS to each phase of the three-phase AC power source. By performing control in each phase, it is possible to cope with a three-phase unbalanced voltage. In such a case, the current triple harmonic caused by star-delta transform is advantageously eliminated. Accordingly, a multiphase AC power source stabilizing system that eliminates an unbalanced voltage can be realized by inserting the AC voltage control device according to the present invention to each phase of a multiphase AC power source such as a three-phase AC power source.

A harmonic generation preventing system that eliminates the current triple harmonic caused by star-delta transform can also be realized by inserting the AC voltage control device according to the present invention to each phase of a three-phase AC power source.

In a case where the power factor of the load has already been improved, the AC voltage control device according to the present invention cannot increase the load voltage any more. However, if the load voltage is only to be lowered, the power-factor improving capacitor Cpf should be provided on the load side, and the power factor is then improved.

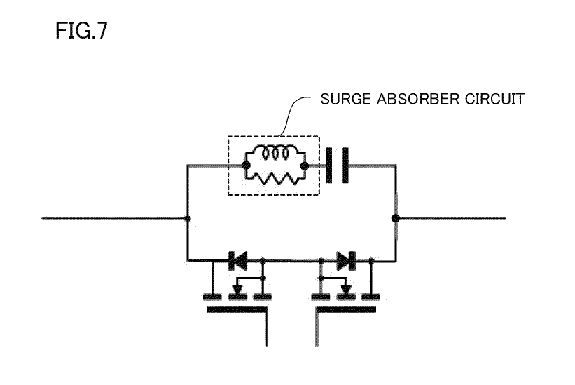

Since the AC voltage control device according to the present invention is a capacitor input circuit, a surge absorber circuit can be added to the AC voltage control device, in case harmonic flows from the AC power source. As an example of the surge absorber circuit, a parallel circuit in which an inductor L and a resistance R are connected in parallel to each other is connected in series to a capacitor, as illustrated in FIG. 7.

1. An AC voltage control device that is inserted between an AC power source and an inductive load, performs a control operation to increase and decrease a load voltage, and has a variable reactance voltage generating function, the AC voltage control device comprising:
a variable reactance voltage generator circuit that includes an AC switch circuit and a capacitor that is connected in parallel to the AC switch circuit, the AC switch circuit including two reverse-conductive field effect transistors (hereinafter referred to as the FETs), a source of a first FET of the two FETs being connected to a source of a second FET of the two FETs, the capacitor storing magnetic energy of the inductive load as electrostatic energy of charges;
a control unit that supplies a control signal to respective gates of the first and second FETs, and controls switching the AC switch circuit on and off; and
a capacitor-voltage zero detection circuit that detects time when a voltage of the capacitor becomes almost zero, and transmits an ON signal about the AC switch circuit to the control unit,
wherein
a capacitance of the capacitor is set so that a resonance frequency determined by the capacitance of the capacitor and an inductance of the inductive load becomes higher than a frequency of the AC power source, and the capacitor has enough capacity to store the magnetic energy of the inductive load as the electrostatic energy of the charges,
the control unit causes the capacitor to charge and discharge the magnetic energy of the inductive load as the electrostatic energy in the form of charges to generate a reactance voltage by simultaneously switching the two FETs of the AC switch circuit off a predetermined period of time after simultaneously switching the two FETs on at the time of receipt of the ON signal, the control unit adjusting an increase and a decrease of the load voltage by varying the reactance voltage through adjustment of the predetermined period of time, the predetermined period of time being equal to or longer than a period of time required for the charging and discharging of the capacitor, the predetermined period of time being equal to or shorter than half a cycle of the AC power source.

2. The AC voltage control device according to claim 1, wherein the AC switch circuit is replaced with an AC switch circuit that includes diode bridges and a self-turn-off semiconductor switch such as a GTO thyristor, an IGBT, an IEGT, a GCT thyristor, or a power MOSFET, the self-turn-off semiconductor switch being connected between DC terminals of the diode bridges.

3. The AC voltage control device according to claim 1, wherein the AC switch circuit including the two FETs is replaced with an AC switch circuit that includes a triac or two thyristors connected in anti-parallel to each other.

4. The AC voltage control device according to claim 1, wherein a surge absorber circuit formed by connecting a resistor and a coil in parallel to each other is connected in series to the capacitor in the variable reactance voltage generator circuit.

5. A lighting control system that controls brightness of an electric-discharge lamp with the AC voltage control device according to claim 1, the inductive load being the electric-discharge lamp having inductive properties, such as a fluorescent lamp, a mercury lamp, or a sodium vapor lamp.

6. An electric motor control system which controls outputs of the electric motor with the AC voltage control device according to claim 1, wherein the inductive load is the electric motor.

7. A multiphase AC power source stabilizing system which eliminates an unbalanced voltage, the AC voltage control device according to claim 1 being connected to each phase of a multiphase AC power source such as a three-phase AC power source.

8. A harmonic generation preventing system which eliminates current triple harmonic through star-delta transform, the AC voltage control device according to claim 1 being connected to each phase of a three-phase AC power source.

9. The AC voltage control device according to any one of claim 2, wherein a surge absorber circuit formed by connecting a resistor and a coil in parallel to each other is connected in series to the capacitor in the variable reactance voltage generator circuit.

10. The AC voltage control device according to any one of claim 3, wherein a surge absorber circuit formed by connecting a resistor and a coil in parallel to each other is connected in series to the capacitor in the variable reactance voltage generator circuit.

11. A lighting control system that controls brightness of an electric-discharge lamp with the AC voltage control device according to any one of claim 2, the inductive load being the electric-discharge lamp having inductive properties, such as a fluorescent lamp, a mercury lamp, or a sodium vapor lamp.

12. A lighting control system that controls brightness of an electric-discharge lamp with the AC voltage control device according to any one of claim 3, the inductive load being the electric-discharge lamp having inductive properties, such as a fluorescent lamp, a mercury lamp, or a sodium vapor lamp.

13. A lighting control system that controls brightness of an electric-discharge lamp with the AC voltage control device according to any one of claim 4, the inductive load being the electric-discharge lamp having inductive properties, such as a fluorescent lamp, a mercury lamp, or a sodium vapor lamp.

14. An electric motor control system which controls outputs of the electric motor with the AC voltage control device according to any one of claim 2, wherein the inductive load is the electric motor.

15. An electric motor control system which controls outputs of the electric motor with the AC voltage control device according to any one of claim 3, wherein the inductive load is the electric motor.

16. An electric motor control system which controls outputs of the electric motor with the AC voltage control device according to any one of claim 4, wherein the inductive load is the electric motor.

17. A multiphase AC power source stabilizing system which eliminates an unbalanced voltage, the AC voltage control device according to any one of claim 2 being connected to each phase of a multiphase AC power source such as a three-phase AC power source.

18. A multiphase AC power source stabilizing system which eliminates an unbalanced voltage, the AC voltage control device according to any one of claim 3 being connected to each phase of a multiphase AC power source such as a three-phase AC power source.

19. A multiphase AC power source stabilizing system which eliminates an unbalanced voltage, the AC voltage control device according to any one of claim 4 being connected to each phase of a multiphase AC power source such as a three-phase AC power source.

20. A harmonic generation preventing system which eliminates current triple harmonic through star-delta transform, the AC voltage control device according to any one of claim 2 being connected to each phase of a three-phase AC power source.

21. A harmonic generation preventing system which eliminates current triple harmonic through star-delta transform, the AC voltage control device according to any one of claim 3 being connected to each phase of a three-phase AC power source.

22. A harmonic generation preventing system which eliminates current triple harmonic through star-delta transform, the AC voltage control device according to any one of claim 4 being connected to each phase of a three-phase AC power source.
